(19) United States
(12) Patent Application Publication
(10) Pub. No.: US 2017/0161647 A1
(43) Pub. Date: Jun. 8, 2017

(54) System and Method for Managing and Prioritizing Venue Performance Holds

(71) Applicant: EventBooking.com, LLC, Knoxville, TN (US)

(72) Inventor: John Platillero, Knoxville, TN (US)

(21) Appl. No.: 15/097,958

(22) Filed: Apr. 13, 2016

Related U.S. Application Data
(60) Provisional application No. 62/262,958, filed on Dec. 4, 2015.

(51) Int. Cl. G06Q 10/02

(52) U.S. Cl. CPC G06Q 10/02

(57) ABSTRACT

A system and method for prioritizing venue performance hold requests is provided. The method includes providing a holds management; receiving on the holds management database at least a first venue hold request transmission including data related to requested hold dates at a particular venue and an identity of a touring act; identifying with the processor hold dates and an identity of the touring act from the hold request transmission; storing the one or more requested hold dates and touring act identity on the holds management database; assigning each of the requested hold dates a hold priority position for the requested hold date; and grouping each of the prioritized requested hold dates on the database with the stored identity of the requesting touring act such that each of the prioritized requested hold dates is associated with the identity of the touring act of the hold request transmission.

### CROSS-REFERENCE TO RELATED APPLICATION

This application claims priority to U.S. Patent Application Ser. No. 62/262,958 to John Platillero for a System and Method for Managing and Prioritizing Venue Performance Holds, which was filed on Dec. 4, 2015, the contents of which are incorporated herein by reference in its entirety.

### FIELD

This disclosure relates to the field of entertainment and event promotion and management. More particularly, this disclosure relates to a system and method for managing and prioritizing electronic requests for performance holds for an entertainment venue.

### BACKGROUND

In the live entertainment industry, one of the biggest challenges involves creating a tour route and booking appropriate entertainment venues along that tour route on desired dates. An ideal tour route is routed through contiguously aligned cities such that the tour stops for performances in cities along the route without requiring the tour to traverse great distances or otherwise backtrack between events.

Each city along a tour route may have multiple venues that would be suitable for a particular touring act. Those venues may have requests from multiple touring acts to hold one or more dates for the touring acts to perform at the venue. The venue is required to keep track of when one or more touring acts desire to perform at the venue and prioritize which touring act may perform at the venue on that date. This process makes it extremely difficult to determine which touring act is to perform on a certain date and to re-prioritize touring acts for a venue as touring acts change schedules or book another venue in the same city.

It is also difficult for touring acts to reserve potential dates at multiple venues across multiple cities such that the cities align for a tour. Coordinating with multiple venues in multiple cities may result in a large number of potential dates and priority positions for touring acts wherein a tour planner must then determine which venues will be suitable for the touring act on an appropriate date that fits within the tour's schedule.

What is needed, therefore, is a system and method for managing and prioritizing venue performance holds that allows venues and touring acts to readily plan tour stops for the touring act.

### SUMMARY

The above and other needs are met by a system and method for managing and prioritizing electronic requests for performance holds for an entertainment venue. In a first aspect, a method is provided for prioritizing venue performance hold requests including the steps of: providing a holds management database including a processor and one or more computer readable storage mediums; receiving on the holds management database at least a first venue hold request transmission, the hold request transmission including data related to one or more requested hold dates at a particular venue requested by a touring act and data related to an identity of the touring act transmitting the at least first venue hold request; identifying with the processor one or more hold dates from the hold request transmission received on the holds management database; identifying with the processor data corresponding to an identity of the touring act requesting hold dates at the venue from the at least first venue hold request transmission; storing the one or more requested hold dates identified by the processor on the one or more computer readable storage mediums of the holds management database; storing identified data related to an identity of the touring act on the one or more computer readable storage mediums of the holds management database; assigning each of the requested hold dates a hold priority position for the requested hold date and associating the assigned hold priority position with each of the requested hold dates; and grouping each of the prioritized requested hold dates on the database with the stored identity of the touring act requesting hold dates at the particular venue such that each of the prioritized requested hold dates is associated with the identity of the touring act of the hold request transmission.

In one embodiment, the method for prioritizing holds further includes receiving a transmission on the holds management database for a change to one or more of the requested hold dates for a particular touring act and re-prioritizing hold requests of other touring acts based on a received change to one or more hold dates of the particular touring act sending the transmission.

In another embodiment, the method for prioritizing holds further includes receiving confirmation of a requested hold date on the holds management database confirming a performance date for a touring act; designating the confirmed hold date as a booked event date for the touring act; removing other requested hold dates grouped with an identity of the touring act at the particular venue; re-assigning priority positions to requested hold dates of other touring acts stored on the holds management database based on a change to the hold request by the touring act for that particular date confirmation of a requested hold date by a touring act confirming a performance date.

In yet another embodiment, the method for prioritizing holds further includes generating an alert on the holds management database that notifies a touring act that a requested hold date has been re-assigned a priority position and transmitting the alert to the touring act. In one embodiment, the transmission from the particular touring act is a request to relinquish a particular hold date of the touring act.

In one embodiment, the method for prioritizing holds further includes displaying a user interface on a display of a computer in communication with the holds management database, the user interface including a calendar displaying data related to each of the requested hold dates of one or more touring acts stored on the holds management database. In another embodiment, the calendar is displayed on a venue terminal in communication with the holds management database and includes dates from all touring acts that have transmitted hold requests for the particular venue. In yet another embodiment, the calendar is displayed on a touring act terminal in communication with the holds management database and includes dates only corresponding to the particular touring act viewing the calendar on the touring act terminal.

In one embodiment, the method for prioritizing holds further includes assigning priority positions to requested hold dates based on input from a user on the user interface of the computer in communication with the holds management database and automatically re-prioritizing requested hold dates of other touring acts stored on the holds management database based on priority positions assigned by the user on the user interface.

In another embodiment, the holds management database assigns a first hold request for a particular date a second hold position on the particular date. In yet another embodiment, the method for prioritizing holds further includes designating one or more touring acts as a preferred touring act, analyzing a received hold request with a processor on the holds management database to determine whether the hold request is from a touring act identified as a preferred touring act, and automatically assigning the received hold request a first hold position if the processor of the holds management database identifies the requesting touring act as a preferred touring act.

In a second aspect, a system of managing and prioritizing performance hold requests at a venue is provided including one or more processors, memory components, and instructions stored on the memory components operable on the one or more processors to perform operations including: receiving at least a first venue hold request transmission, the hold request transmission including data related to one or more requested hold dates at a particular venue requested by a first touring act and data related to an identity of the first touring act transmitting the at least first venue hold request; identifying one or more hold dates and an identity of the first touring act of the first venue hold transmission; storing the one or more hold dates such that the one or more hold dates are grouped with the identified first touring act requesting the hold dates; assigning each of the one or more hold dates a priority position on each requested hold date based on one or more prioritized hold dates of other touring acts; and storing the assigned priority position of each requested hold date of the first touring act.

In one embodiment, the system of managing and prioritizing performance hold requests further includes receiving a request to book one of the prioritized requested hold dates from the first touring act, releasing other prioritized requested hold dates of the first touring act, automatically re-prioritizing requested hold dates of other touring acts based on release of prioritized requested hold dates of the first touring act, and storing the re-assigned priority positions of the re-prioritized requested hold dates of the other touring acts.

In a third aspect, a system of managing and prioritizing performance hold requests at a venue is provided including: at least one touring act terminal including one or more processors, memory components, and a display; at least one venue terminal including one or more processors, memory components, and a display; a holds management database including one or more processors, memory components, and instructions stored on the memory components, the holds management database in electronic communication with the at least one touring act terminal and at least one venue terminal via a network, the holds management database configured to receive at least a first venue hold request transmission, the hold request transmission including data related to one or more requested hold dates at a particular venue requested by a touring act and data related to an identity of the touring act transmitting the at least first venue hold request, identify one or more hold dates and an identity of the first touring act of the first venue hold transmission, store the one or more hold dates such that the one or more hold dates are grouped with the identified first touring act requesting the hold dates, assign each of the one or more hold dates a priority position on each requested hold date based on one or more prioritized hold dates of other touring acts, store the assigned priority position of each requested hold date of the first touring act, receive a request to book one of the prioritized requested hold dates from the first touring act, release other prioritized requested hold dates of the first touring act, automatically re-prioritizing requested hold dates of other touring acts based on release of prioritized requested hold dates of the first touring act, and storing the re-assigned priority positions of the re-prioritized requested hold dates of the other touring acts.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a table of a list of potential venues for a touring act and a hold status for each venue on a particular date according to one embodiment of the present disclosure;

FIG. 2 illustrates a system and method for managing, prioritizing, and communicating venue performance holds according to one embodiment of the present disclosure;

FIG. 3 shows a venue calendar of a holds management database according to one embodiment of the present disclosure;

FIGS. 4 through 6 illustrate a touring act or venue adding one or more holds for a particular venue according to one embodiment of the present disclosure;

FIG. 7 shows all dates on which the touring act has a hold stored on the holds management database for that venue according to one embodiment of the present disclosure;

FIG. 8 illustrates releasing a touring act hold according to one embodiment of the present disclosure;

FIG. 9 shows a venue calendar of a holds management database according to one embodiment of the present disclosure;

FIG. 10 illustrates confirming and releasing a touring act hold according to one embodiment of the present disclosure;

FIG. 11 shows an updated calendar of events on the holds management database according to one embodiment of the present disclosure; and

FIG. 12 shows a method for receiving hold request transmissions from one or more touring acts and automatically prioritizing and re-prioritizing requested hold dates from a touring act.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

A computer based system and method for managing and prioritizing venue performance holds is provided that allows venues and touring acts to dynamically manage and prioritize holding a performance date at one or more venues on one or more dates. As referred to herein, a touring act may include artists, bands, performers, circus acts, comedians, speakers, and other various acts that perform at various venues. Venues may include stadiums, auditoriums, clubs, arenas, outdoor areas, or other locations suitable for hosting a touring act at an organized event.

The computer based system and method for managing and prioritizing venue performance and synchronizing venue automates holds placed by touring acts at venues such that hold positions of an artist at a particular venue are updated and displayed in real-time or near real-time. A user interface allows artists to specify particular dates as desired dates for performing at a particular venue, and to further view holds placed by the artist along with a position of the holds as they relate to other holds placed by other touring acts on particular dates. One or more algorithms operable on a processor assign a hold position to a requested performance date at a particular venue and automatically adjust a hold position of the requested performance date based on activity by the touring act requesting the particular date or changes in holds of other touring acts.

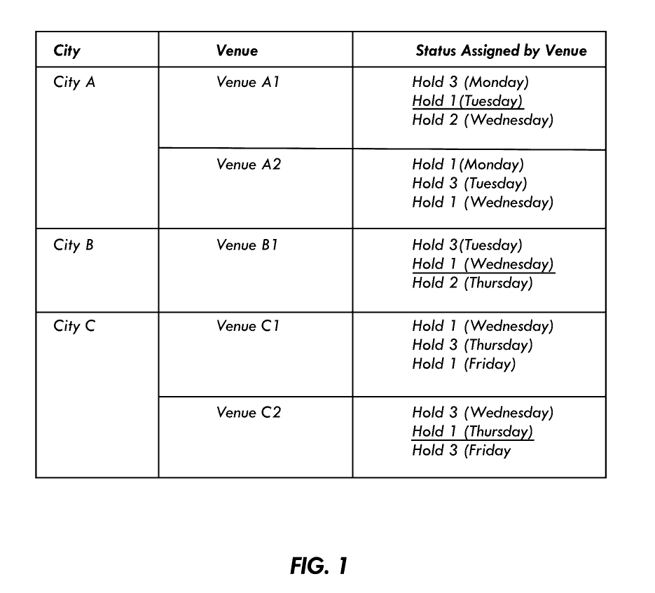

FIG. 1 shows a table of a list of potential venues for a touring act and a hold status for each venue on a particular date. As referred to herein, a hold at a venue is a right of refusal of the touring act to perform at a particular venue, where a “Hold 1” represents a first right of refusal, a “Hold 2” represents a second right of refusal, and “Hold 3” represents a third right of refusal. If a touring act has a second or third right of refusal, that touring act will only be able to perform at the particular venue if the touring act with Hold 1 elects to remove its hold at the venue, thereby elevating the touring act with Hold 2 to a Hold 1 first right of refusal to perform at the venue.

The table of FIG. 1 illustrates a list of holds for one touring act for multiple venues across multiple cities of a planned tour route. In City A, the touring act may have two appropriate venues (Venue A1 and Venue A2), with other venues available in City B and City C along a planned tour route. The touring act may request a number of holds at Venue A1 and Venue A2 based on dates during which the touring act plans to be in City A. The holds are assigned to the touring act at Venue A1 and Venue A2 by the venues based on a number of touring acts that have pre-existing holds at the venues, or assigned at the venue's discretion. For example, the venues may assign a lower hold position on a particular date at its discretion even though no other touring act has already reserved a hold on that particular date. The example illustrated in the table of FIG. 1 shows the touring act having a Hold 1 on Tuesday at Venue A1 and a Hold 1 at Venue A2 on Monday and Wednesday. Based on this information, the touring act would attempt to string together a tour route that incorporates multiple venues in multiple cities where the touring act has Hold 1 and the touring act can perform on contiguous dates in City A, City B, and City C. In this example, the touring act would choose VA1 (Tues.), VB1 (Wed.), VC2 (Thurs.).

Each of the venues will maintain similar information related to a number of holds on particular dates by various touring acts. A difficulty that arises in maintaining various touring act holds is that venues must continue to update holds based on when a touring act elects to book a date, and further must elevate other touring act holds when a touring act with priority drops its hold or selects a date for a performance. Similarly, it is impossible for touring act and touring act managers to know when the touring act's hold is elevated or to determine when a date is available for a touring act to perform based on activity of other touring acts also having holds on particular dates of interest.

A system and method for managing and prioritizing venue performance holds of the present disclosure provides an automated process of managing prioritization of touring act holds at a venue, grouping holds placed by multiple touring acts, re-prioritizing holds, and automatically releasing holds when a touring act selects a performance date. The system further allows touring acts and venues to manage and prioritize holds and communicate a status of those holds with one another. The system for managing and prioritizing venue performance holds communicates a status of a hold between artists and venues and provides real-time or near real-time updates as to a position of a requested hold date.

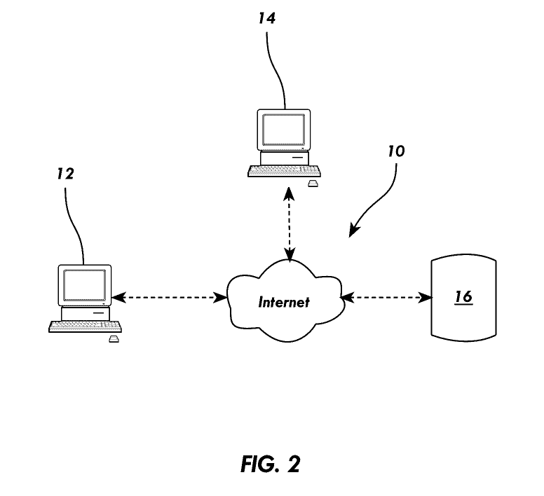

Referring now to FIG. 2, the system includes a network 10 including one or more venue terminals 12, one or more touring act terminals 14, and a holds management database 16. The one or more venue terminals 12, touring act terminals 14, and holds management database 16 are in electronic communication, such as through the Internet. A touring act user and venue user interfaces with the one or more venue terminals 12 and one or more touring act terminals 14 using the Internet or other like communication systems.

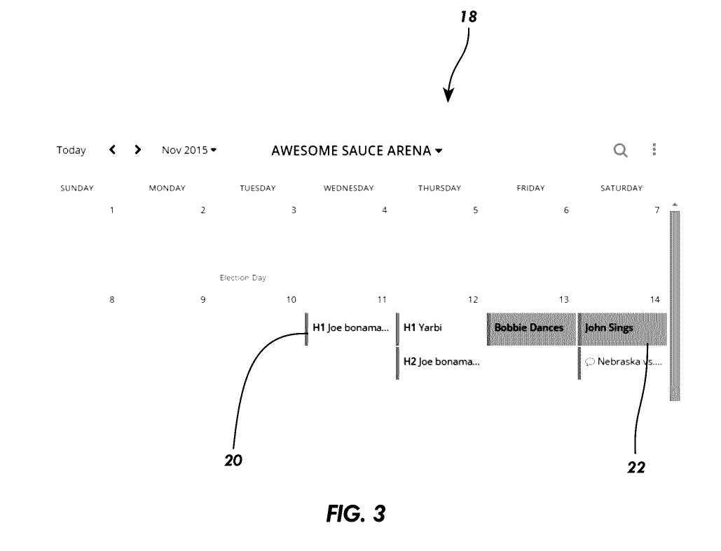

FIG. 3 illustrates a venue calendar accessible on the one or more venue terminals 12 for managing and prioritizing touring act holds. The venue calendar displays on the one or more venue terminals 12, a calendar of dates 18 for a particular venue. The calendar of dates displays one or more existing holds 20 by touring acts, with the appropriate designation of “H1” or “H2” depending on the order of placement of the hold by the touring acts. The calendar of dates also displays one or more booked events 22 on the dates that the events 22 are scheduled to be performed.

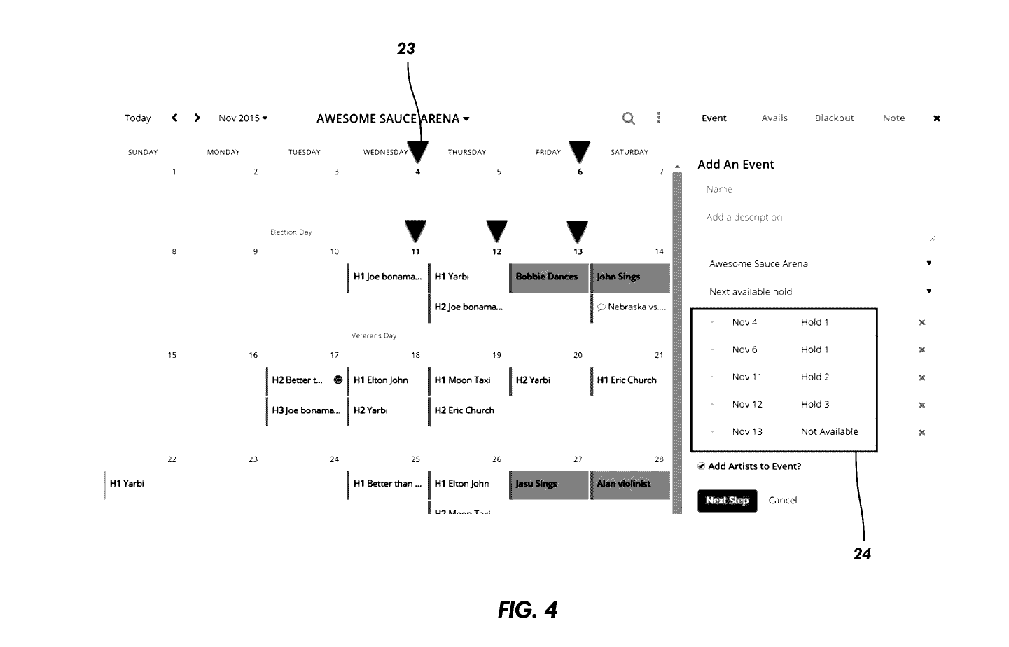

A touring act may request multiple holds across multiple dates, and FIG. 4 illustrates a touring act or venue adding one or more holds for a particular venue. The calendar is displayed on a user interface of the venue terminal 12, and a user selects one or more dates 23 of the calendar as potential dates for performing at the venue. Upon selecting the one or more potential dates 23, the dates are grouped together and displayed in an event suggested ranking area 24 displayed on the venue terminal 12. The suggested ranking area 24 displays the selected dates grouped together under a particular event for the touring act along with a suggested hold status for each date desired. In the example shown in FIG. 4, a Hold 1 status is automatically suggested for November 4 and November 6 because no other events are stored in the holds management database 16 as corresponding to those dates. A Hold 2 and Hold 3 status are automatically suggested for November 11 and November 12 because prior holds have been stored on the holds management database 16 for an event on those dates. “Date not available” is displayed for the November 13 date because an event is already booked for that particular date.

A calendar user interface may also be displayed to the one or more touring acts on the one or more touring act terminals 14. The calendar user interface displayed on the one or more touring act terminals includes a list of all dates on which the particular touring act has a hold and the respective hold positions. Where the touring act has multiple hold requests across multiple venues that have received hold request transmissions, those hold requests are displayed on the calendar along with an identity of the venue and the hold position. When a touring act user views the calendar on the touring act terminal 14, only requested hold dates for that touring act may be displayed and the touring act may not be able to view requested holds by other touring acts for a particular venue.

When the holds management database 16 receives a hold request related to one or more touring acts, identifying data of the touring act is pulled from the hold request and stored on the holds management database 16. Identifying data may include the name, location, genre, and other information related to the touring act. Data related to an identity of a touring act may be pulled from a third party database that is in communication with the holds management database 16 such that when a name or other information is received on the holds management database 16, other information regarding the touring act such as other tour dates, ranking of the touring act's songs, and other information are retrieved.

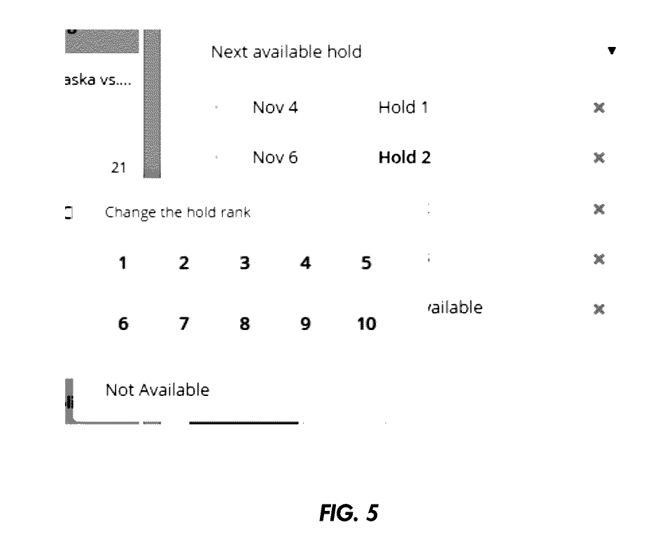

A venue user may alter a hold status for each suggested date. For example, a user may, via either the venue terminal 12, change a suggested Hold 1 status to a Hold 2 status or vice versa, even though no existing holds are stored on the holds management database 16 for that date, as illustrated in FIG. 5. When a user changes a suggested hold, the system generates an alert that is transmitted to the touring act to notify the touring act of the change in hold position. Preferably only the venue is able to alter a requested hold position of a touring act.

In one embodiment, data related to an identity of one or more preferred touring acts may be stored on the holds management database 16. Preferred touring acts that are stored on the holds management database 16 may include one or more acts that are popular, have performed well at a particular venue, or are otherwise a touring act that may be preferred over other touring acts requesting holds at a particular venue. In this embodiment, when a hold request is received on the holds management database 16, an identity of a performing act requesting a hold date is compared against identities of the one or more preferred touring acts stored on the holds management database 16. If the identity of the touring act requesting the hold date corresponds to an identity of a preferred touring act, and other touring acts already have holds on those dates, the preferred touring act may be assigned a highest priority hold above other touring acts on that particular date.

For example, the system may be configured by default to automatically assign a first received hold request transmission for a particular date a second hold position even though no hold requests are already requested by other touring acts for that particular day. If a touring act is identified as a preferred touring act, a hold request transmission from that touring act may be assigned a first hold position above any other touring acts that were assigned a default second hold position on that particular date.

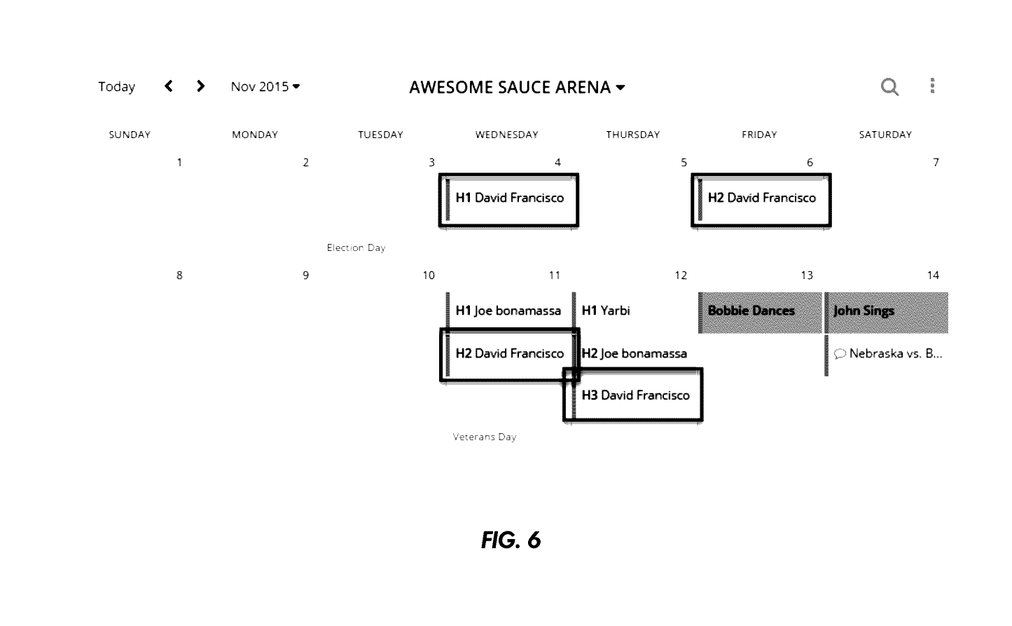

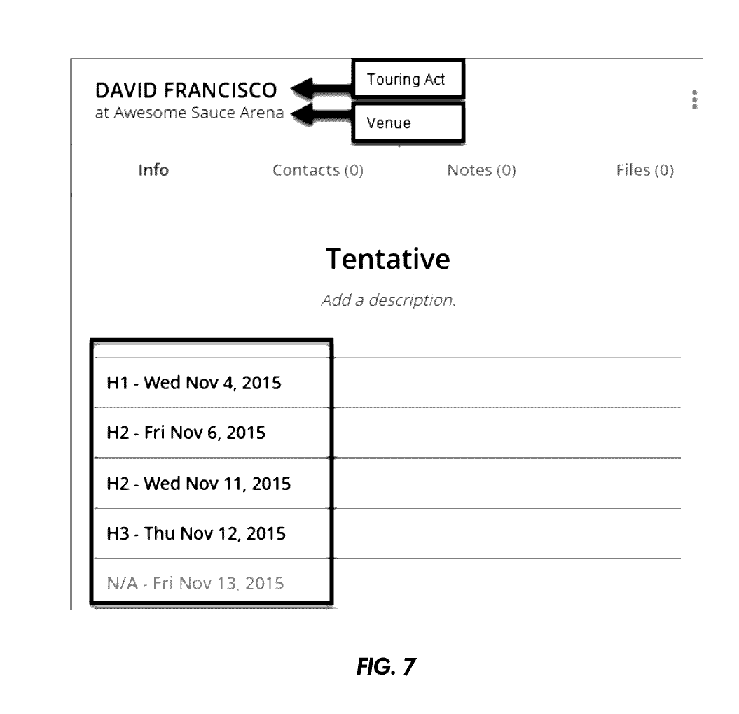

Referring now to FIG. 6, after selecting one or more dates and requesting holds for those dates, the holds are stored on the holds management database 16 and displayed to the venue and one or more touring acts on a display of the one or more venue terminals 12 and touring act terminals 14. While the holds are separately displayed on each individual date, each hold is associated with other holds of the same event on the holds management database 16. For example, FIG. 7 displays all grouped hold dates related to a particular event for a touring act at a venue. The display of FIG. 7 shows all dates on which the touring act has a hold stored on the holds management database for that venue. The touring act or venue may then select one or more of those dates to book the touring act's event on that date.

The system and method for managing and prioritizing venue performance holds further automatically promotes and removes holds as touring acts adjust dates, book events, or remove previously requested holds such that other touring acts with holds on the same dates are subsequently promoted. The system of the present disclosure automatically updates an event's hold status based on changes to that event or changes to other events that have hold priority over the particular event. {clarify that venue controls hold priority position}.

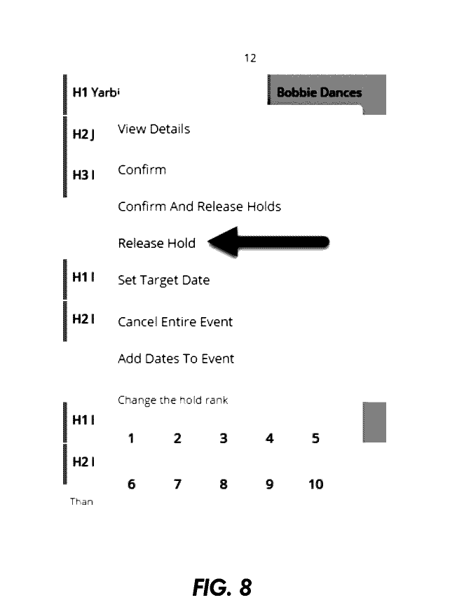

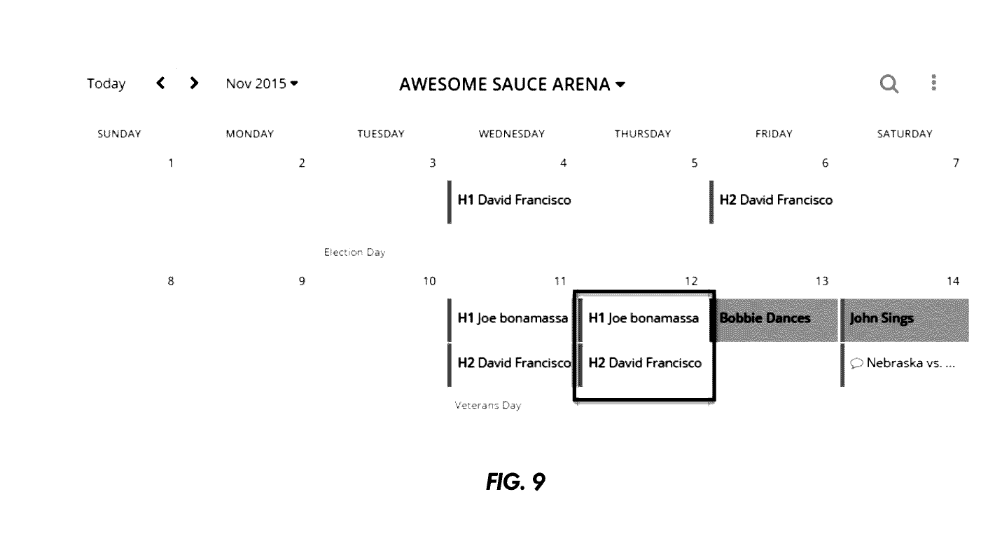

As shown in FIG. 8, a user may select an event date for a particular touring act and select one of a number of options for that particular event on the selected date. In one step, a user may select, through an interface of the one or more touring act terminals or venue terminals, to release a hold for that particular date. Releasing a hold corresponds to a touring act no longer needing a hold on a particular date, such as if a schedule for the touring act is adjusted such that the selected date is no longer desirable. Upon selecting release of a hold on that particular date, the touring act's hold is removed from the particular event and that event date stored with the touring act on the holds management database 16 is deleted. The holds management database 16 automatically promotes any lower ranked holds on the same date to a higher position, as illustrated in FIG. 9. For example, events that were previously designated Hold 2 and Hold 3 have been promoted to Hold 1 and Hold 2 after release of the prior Hold 1 held by the touring act that released the hold.

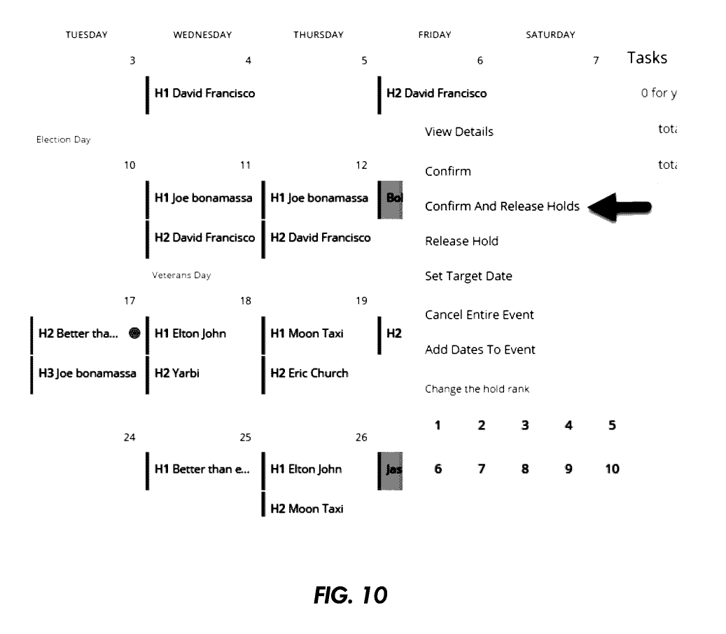

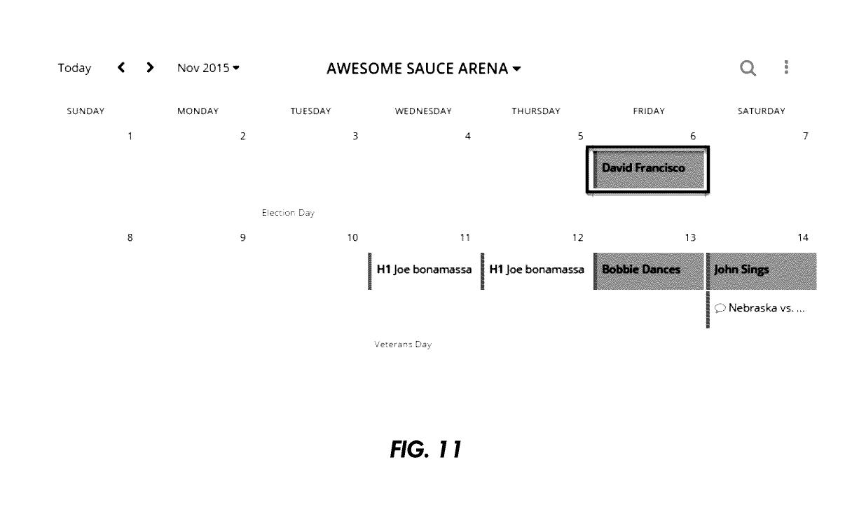

Referring to FIG. 10, a user may select an event date to confirm booking of a touring act event on a particular date and then release any other holds that the touring act may have stored on the holds management database 16 for the event. The user selects a confirm and release hold for an event on a particular date, thereby booking the event on that date. The holds management database 16 will remove any other hold dates for that touring act's particular event from the holds management database 16. FIG. 11 shows an updated calendar of events on the holds management database 16 wherein the touring act hold has been confirmed as a booked event, and other holds of that touring act have been removed from other dates originally requested by the confirming touring act. In one embodiment, when a touring act confirms a hold date, other touring acts are automatically notified by the holds management database 16 that the particular date confirmed by the other touring act is no longer available. The other touring acts may be notified by automatically generating a notification transmission on the holds management database 16 and transmitting the notification transmission to touring act terminals 14 of the other touring acts.

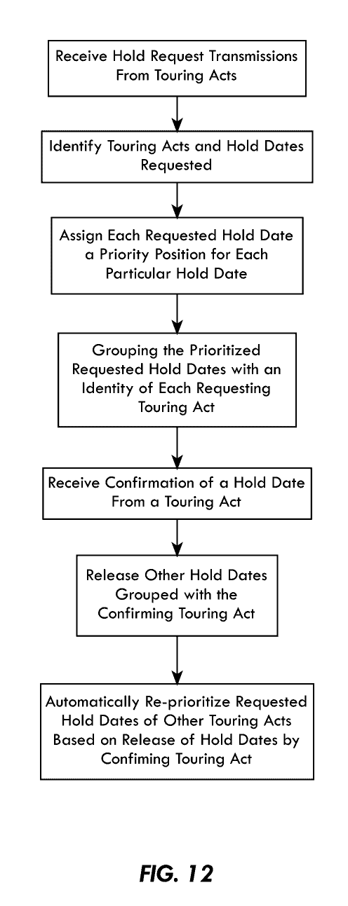

Referring to FIG. 12, a method is provided for receiving hold request transmissions from one or more touring acts and automatically prioritizing and re-prioritizing requested hold dates from a touring act. The method includes the steps of receiving one or more hold request transmissions from touring acts and identifying the touring act and hold dates requested. Each hold date of the received hold request transmission is assigned a priority position. The prioritized hold dates are grouped according to the touring act requiring the requested hold dates. Upon confirming a performance date for a touring act, a confirmation is received confirming one of the one or more requested hold dates for a touring act. Upon confirmation of a requested performance date, that particular hold request becomes a booked event date at which point any other holds grouped with that particular touring act are released such that the other hold requests of the touring act are no longer prioritized above any other touring acts with hold requests on those dates. Upon release of the other hold requests of the booking touring act, hold requests by other touring acts are automatically re-prioritized based on release of the hold dates held by the booking act.

The system and method for managing and prioritizing venue performance holds also enables direct communication between touring acts, venues, and the holds management database 16 via the one or more venue terminals 12 and touring act terminals 14. Venue users may login to the holds management database 16 via a user interface on the venue terminals 12 and view and manage all holds for the venue and make changes to touring act events with holdings at the venue and stored on the holds management database 16. Similarly, touring act users may login to the holds management database 16 via a user interface on the touring act terminals 14 and view and manage holds for the touring act at various venues.

The holds management database 16 may automatically alert one or more touring acts or venues to a change in a status of one or more holds of the touring acts or venues. For example, the holds management database 16 may generate and transmit an alert to a touring act when that touring act is promoted to a first priority hold position from a lower priority hold position. If a touring act has an H2 hold and a touring act holding the H1 hold on the same date books another date or otherwise releases its hold, the H2 hold touring act may be alerted that it now has an H1 hold on that particular date. Similarly, if a touring act books a date and subsequent holds of other touring acts that have requested holds for that particular date are no longer available, those other touring acts may be alerted by the holds management database 16 that the dates are no longer available to hold.

The system and method for managing and prioritizing venue performance holds of the present disclosure advantageously allows touring acts and venues to manage multiple holds for events to help maintain an order of touring acts requesting to perform at a venue. Further, the system and method for managing and prioritizing venue performance holds allows touring acts to request holds across multiple venues and plan a tour route based on availability of dates and a priority of holds held by the touring act along a planned tour route. Finally, the system and method for managing and prioritizing venue performance holds provides real time and automatic re-prioritizing of holds based on events such as cancelling a hold or booking an event and updates other touring act holds based on the occurrence of those events.

While the above description discusses communication between a venue and touring act, it is also understood that the system described herein may be utilized by one or more promoters on behalf of both venues and touring acts. For example, a touring act promoter may transmit hold requests. Similarly, a promoter on behalf of a venue or concert may alter requested hold dates or otherwise communicate requested hold date information with touring acts or a promoter of the touring acts.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A method for prioritizing venue performance hold requests comprising:
providing a holds management database including a processor and one or more computer readable storage mediums;
receiving on the holds management database at least a first venue hold request transmission, the hold request transmission including data related to one or more requested hold dates at a particular venue requested by a touring act and data related to an identity of the touring act transmitting the at least first venue hold request;
identifying with the processor one or more hold dates from the hold request transmission received on the holds management database;
identifying with the processor data corresponding to an identity of the touring act requesting hold dates at the venue from the at least first venue hold request transmission;
storing the one or more requested hold dates identified by the processor on the one or more computer readable storage mediums of the holds management database;
storing identified data related to an identity of the touring act on the one or more computer readable storage mediums of the holds management database;
assigning each of the requested hold dates a hold priority position for the requested hold date and associating the assigned hold priority position with each of the requested hold dates; and
grouping each of the prioritized requested hold dates on the database with the stored identity of the touring act requesting hold dates at the particular venue such that each of the prioritized requested hold dates is associated with the identity of the touring act of the hold request transmission.

2. The method of claim 1, further comprising:
receiving a transmission on the holds management database for a change to one or more of the requested hold dates for a particular touring act;
re-prioritizing hold requests of other touring acts based on a received change to one or more hold dates of the particular touring act sending the transmission.

3. The method of claim 1, further comprising:
receiving confirmation of a requested hold date on the holds management database confirming a performance date for a touring act;
designating the confirmed hold date as a booked event date for the touring act;
removing other requested hold dates grouped with an identity of the touring act at the particular venue;
re-assigning priority positions to requested hold dates of other touring acts stored on the holds management database based on a change to the hold request by the touring act for that particular date confirmation of a requested hold date by a touring act confirming a performance date.

4. The method of claim 3, further comprising generating an alert on the holds management database that notifies a touring act that a requested hold date has been re-assigned a priority position and transmitting the alert to the touring act.

5. The method of claim 2, wherein the transmission from the particular touring act is a request to relinquish a particular hold date of the touring act.

6. The method of claim 1, further comprising displaying a user interface on a display of a computer in communication with the holds management database, the user interface including a calendar displaying data related to each of the requested hold dates of one or more touring acts stored on the holds management database.

7. The method of claim 6, wherein the calendar is displayed on a venue terminal in communication with the holds management database and includes dates from all touring acts that have transmitted hold requests for the particular venue.

8. The method of claim 6, wherein the calendar is displayed on a touring act terminal in communication with the holds management database and includes dates only corresponding to the particular touring act viewing the calendar on the touring act terminal.

9. The method of claim 6, further comprising:
assigning priority positions to requested hold dates based on input from a user on the user interface of the computer in communication with the holds management database
automatically re-prioritizing requested hold dates of other touring acts stored on the holds management database based on priority positions assigned by the user on the user interface.

10. The method of claim 1, wherein the holds management database assigns a first hold request for a particular date a second hold position on the particular date.

11. The method of claim 10, further comprising:
designating one or more touring acts as a preferred touring act;
analyzing a received hold request with a processor on the holds management database to determine whether the hold request is from a touring act identified as a preferred touring act;
automatically assigning the received hold request a first hold position if the processor of the holds management database identifies the requesting touring act as a preferred touring act.

12. A system of managing and prioritizing performance hold requests at a venue comprising one or more processors, memory components, and instructions stored on the memory components operable on the one or more processors to perform operations comprising:
receiving at least a first venue hold request transmission, the hold request transmission including data related to one or more requested hold dates at a particular venue requested by a first touring act and data related to an identity of the first touring act transmitting the at least first venue hold request;
identifying one or more hold dates and an identity of the first touring act of the first venue hold transmission;
storing the one or more hold dates such that the one or more hold dates are grouped with the identified first touring act requesting the hold dates;
assigning each of the one or more hold dates a priority position on each requested hold date based on one or more prioritized hold dates of other touring acts; and
storing the assigned priority position of each requested hold date of the first touring act.

13. The system of claim 6 further comprising:
receiving a request to book one of the prioritized requested hold dates from the first touring act;
releasing other prioritized requested hold dates of the first touring act;
automatically re-prioritizing requested hold dates of other touring acts based on release of prioritized requested hold dates of the first touring act; and
storing the re-assigned priority positions of the re-prioritized requested hold dates of the other touring acts.

14. A system of managing and prioritizing performance hold requests at a venue comprising
at least one touring act terminal including one or more processors, memory components, and a display;
at least one venue terminal including one or more processors, memory components, and a display;
a holds management database including one or more processors, memory components, and instructions stored on the memory components, the holds management database in electronic communication with the at least one touring act terminal and at least one venue terminal via a network, the holds management database configured to:
receive at least a first venue hold request transmission, the hold request transmission including data related to one or more requested hold dates at a particular venue requested by a touring act and data related to an identity of the touring act transmitting the at least first venue hold request;
identify one or more hold dates and an identity of the first touring act of the first venue hold transmission;
store the one or more hold dates such that the one or more hold dates are grouped with the identified first touring act requesting the hold dates;
assign each of the one or more hold dates a priority position on each requested hold date based on one or more prioritized hold dates of other touring acts;
store the assigned priority position of each requested hold date of the first touring act;
receive a request to book one of the prioritized requested hold dates from the first touring act;
release other prioritized requested hold dates of the first touring act;
automatically re-prioritizing requested hold dates of other touring acts based on release of prioritized requested hold dates of the first touring act; and
storing the re-assigned priority positions of the re-prioritized requested hold dates of the other touring acts.
